(19) United States
(12) Patent Application Publication
(10) Pub. No.: US 2019/0235621 A1
(43) Pub. Date: Aug. 1, 2019

(54) Method and apparatus for showing an expression of how an object has been stared at in a displayed video

(71) Applicant: Snail Innovation Institute, San Jose, CA (US)

(72) Inventors: Darwin Hu, San Jose, CA (US); Hai Shi, Suzhou (CN)

(21) Appl. No.: 15/881,688

(22) Filed: Jan. 26, 2018

(51) Int. Cl. G06F 3/01; G06T 7/246; H04N 9/31; G02B 27/01

(52) U.S. Cl. CPC G06F 3/013; G06T 7/248; H04N 9/3173; G02B 2027/0178; G06T 2207/30241; G06T 2207/30201; G02B 27/0172

(57) ABSTRACT

Architecture and designs of wearable display devices for are described. According to one aspect of the present invention, a wearable display device is equipped with an external display device facing outwards. In other words, the external display device is not meant for the wearer of the wearable display device but used for the wearer to engage with a person before or in the vicinity of the wearer. The external display device may be turned on manually or automatically to display an expression. Depending on implementation or application, the expression may be a text, a symbol or an emoji with or without reference to the content being displayed in the wearable display devices.

### BACKGROUND OF THE INVENTION

### Field of the Invention

The present invention generally relates to the area of display devices and more particularly relates to architecture and designs of display devices that show an emotion expression in an event, where such a display device may be used in various applications including gaming, virtual reality and augmented reality. Examples of the event include, but may not be limited to, expression of feeling towards another person in the vicinity of a wearer, sharing feeling of the wearer when viewing specific content being displayed in the glasses and displaying an expression when the wearer has starred at a certain object in content being displayed in the glasses for a predefined period of time.

### Description of the Related Art

Display glasses, also referred to as wearable display device, are an optical head-mounted display designed in the shape of a pair of eyeglasses. It was originally developed with the mission of producing a ubiquitous computer. Such a display device displays information in a smartphone-like hands-free format. Wearers communicate with the Internet via a command (e.g., voice and gesture). The popular area that such wearable display devices were used was related to gaming. A gamer using the equipment is typically able to look around a generated three-dimensional environment, moves around in it and interacts with features or objects that are depicted on a screen or in goggles.

With the introduction of virtual reality (VR) and augmented reality (AR), the wearable display devices are quickly coming into the mainstream. Nearly all AR and VR applications relies on wearable display devices to deliver the contents. The head-mounted display typically take the form of head-mounted goggles with a screen in front of the eyes. Virtual Reality actually brings the user into the digital world by cutting off outside stimuli. In this way user is solely focusing on the digital content being displayed in the HMDs. Various artificially generated three-dimensional environment are created to take the unique features of the wearable display devices. They are also used to display score overlays on telecasted sports games and pop out 3D emails, photos or text messages on mobile devices. Leaders of the tech industry are also using AR to do amazing and revolutionary things with holograms and motion activated commands.

FIG. 1A shows an exemplary goggle now commonly seen in the market for the application of displaying videos, delivering VR or AR. No matter how a goggle is designed, it appears enclosed and private. In other words, when a user wears a goggle, he or she would ignore or not be able to interact with others surrounding him/her. Thus, there is a need for an apparatus that can display video or VR/AR content but also allows a wearer to keep others engaged if needed. FIG. 1B shows a sketch of HoloLens from Microsoft. It also demonstrate its enclosed or private features that prevent a wearer from interacting with someone the wearer is talking with, sharing what the wearer is interested in or impressing others with his/her feeling at a moment. Thus there is a further need for a wearable viewing or display device that looks similar to a pair of regular glasses but is also an expression device to someone the wearer is interacting with.

### SUMMARY OF THE INVENTION

This section is for the purpose of summarizing some aspects of the present invention and to briefly introduce some preferred embodiments. Simplifications or omissions in this section as well as in the abstract and the title may be made to avoid obscuring the purpose of this section, the abstract and the title. Such simplifications or omissions are not intended to limit the scope of the present invention.

The present invention is generally related to architecture and designs of wearable display devices. According to one aspect of the present invention, a wearable display device is made in form of a pair of glasses and includes a minimum number of parts to reduce the complexity and weight thereof. A separate case or enclosure is provided as portable to be affixed or attached to a user (e.g., a pocket or waist belt). The enclosure includes all necessary parts and circuits to generate content for display in the glasses. Each of the lenses includes a specially designed transparent medium (e.g., prism or light waveguide) to receive an image from the enclosure and present the image for viewing by the wearer.

There is at least one external display positioned on or near a frame of the glasses, where the external display is not meant for the wearer and faces outward so that a person nearby or in the vicinity of the wearer may see the external display. The display is used by the wearer to display something to get the person engaged or is to display predefined content in accordance with what the wearer is or has been viewing. Depending on implementation, the external display may display an expression (message, a symbol or an emoji or other indicator) and may be implemented in LED, LCD, OLED or other display devices. The expression may be generated or selected from a list maintained in the enclosure.

According to another aspect of the present invention, one or both of the lenses in the wearable display devices may be rotated outwards (e.g., flipped over) to act as an external display when needed. When the lens is rotated, it is optionally no longer displaying the image that is being displayed in the other lens the wearer is viewing and changed to display the expression. When the wearer desired to share what he/she is viewing, the image can be displayed on the rotated or flipped lens.

According to yet another aspect of the present invention, the external display may be used to indicate how long the wearer has been looking at a designated object in a scene displayed in the glasses, express some feeling of the wearer, or share the content being viewed with others.

The present invention may be implemented as an apparatus, a method, a part of system. Different implementations may yield different benefits, objects and advantages. In one embodiment, the present invention is a wearable display device comprising: at least an integrated lens being held in a frame; an external display mounted on or near the frame to display electronically an expression from a wearer of the wearable display device, wherein the external display faces outwards so that a person sits or stands in front of the wearer sees what is being displayed on the external display; a pair of temples, at least one temple coupled to a cable, wherein the cable is extended beyond the temple to receive a video from a wearable case; and a projection mechanism, disposed near an end of the temple, receiving the video and projecting the video into the integrated lens, wherein the wearer sees the video in the integrated lens.

In another embodiment, the present invention is a method for a wearable display device to display an impression, the wearable display device including at least an integrated lens being held in a frame, the method comprises: mounting an external display mounted on or near the frame; and displaying electronically an expression on the external display, wherein the external display faces outwards so that a person sits or stands in front of the wearer sees the expression on the external display, and wherein the wearable display device further includes: a pair of temples, at least one temple coupled to a cable, wherein the cable is extended beyond the temple to receive a video from a wearable case; and a projection mechanism, disposed near an end of the temple, receiving the video and projecting the video into the integrated lens, wherein the wearer sees the video in the integrated lens.

In still another embodiment, the present invention is a wearable display device for reporting tracking of a predefined object in a video, the wearable display device comprises: at least an integrated lens being held in a frame; an external display facing outwards so that a person sits or stands in front of the wearer sees what is being displayed on the external display; a pair of temples, at least one temple coupled to a cable extended beyond the temple to receive the video from a wearable case; a projection mechanism, disposed near an end of the temple, receiving the video and projecting the video into the integrated lens and at least a sensor, mounted near or on the frame, provided to focus onto a pupil starring at the predefined object moving in the video, wherein the external display displays an expression to show how the wearer has been following the predefined object moving in the video.

In yet another embodiment, the present invention is a method for a wearable display device to report tracking of a predefined object in a video, the method comprises receiving the video via a cable in the wearable display device, wherein the wearable display device includes: at least an integrated lens being held in a frame; an external display facing outwards so that a person sits or stands in front of the wearer sees what is being displayed on the external display; a pair of temples, at least one temple coupled to a cable, wherein the cable is extended beyond the temple to receive the video from a wearable case; a projection mechanism, disposed near an end of the temple, receiving the video and projecting the video into the integrated lens, wherein the wearer sees the video in the integrated lens. The method further comprises generating a set of images from a sensor, mounted near or on the frame, provided to focus onto a pupil starring at the predefined object moving in the video; and displaying on the external display an expression to show how the wearer has been following the predefined object moving in the video.

There are many other objects, together with the foregoing attained in the exercise of the invention in the following description and resulting in the embodiment illustrated in the accompanying drawings.

### BRIEF DESCRIPTION OF THE DRAWINGS

These and other features, aspects, and advantages of the present invention will become better understood with regard to the following description, appended claims, and accompanying drawings where:

FIG. 1A shows an exemplary goggle now commonly seen in the market for the application of delivering or displaying VR or AR;

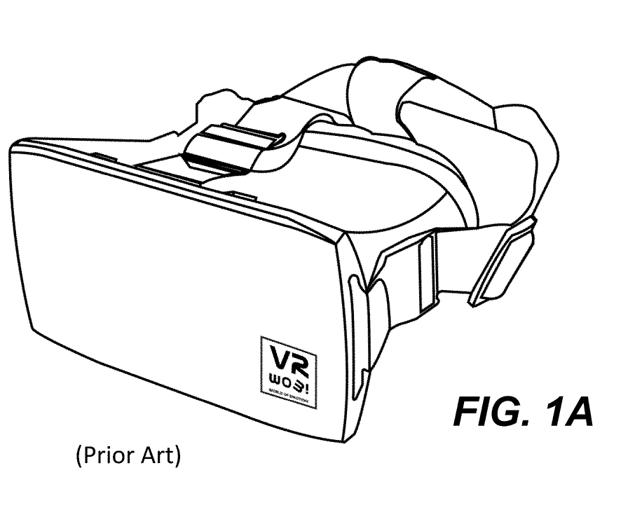

FIG. 1B shows a sketch of HoloLens from Microsoft;

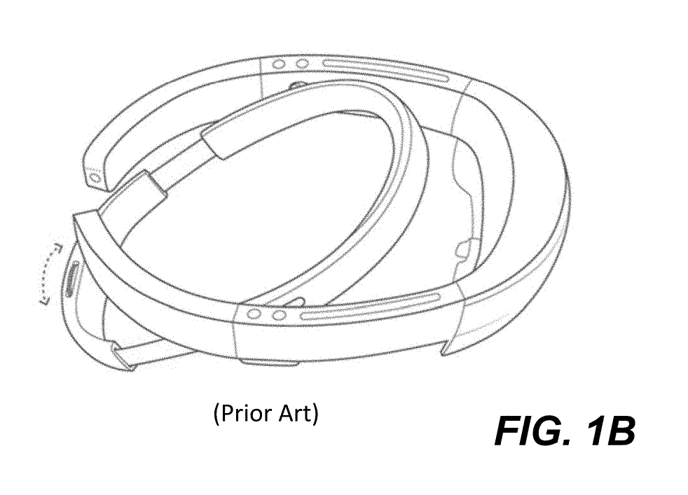

FIG. 2A shows a pair of exemplary glasses implemented with an external display to shown an expression to others according to one embodiment of the present invention;

FIG. 2B shows an example of a wearer or user wearing the glasses of FIG. 2A with an emoji display;

FIG. 2C shows one embodiment in which a case is implemented to include a touch pad that allows a wearer to move a finger (not shown) to a certain position to activate a command or to select an emoji from a collection of emojis;

FIG. 2D shows an example in which a wearable display device (display glasses) is controlled by a smartphone via a controller, where the controller is operated by a thumb or fingers;

FIG. 2E shows an example of images projected into a pair of transparent lenses that may be viewed by the wearer or a person in front of the wearer, where the images may be flipped for the person viewing from outside when needed;

FIG. 2F shows an example in which one of the glasses lenses is flipped over to share a person in front of the wearer what is being displayed;

FIG. 3A shows a diagram in which a sensor is mounted or embedded near a special lens;

FIG. 3B shows an example of a scene in which a performer is wearing a pair of display glasses that is coupled to a wearable case, very much resembling an example of using one embodiment of the present invention except that the performer is now looking at a camera through one lens of the glasses;

FIG. 3C shows an exemplary lens that may be used in the glasses of FIG. 3A or the glasses shown in FIGS. 2A-2C; and

FIG. 4 shows a functional block diagram of a circuit that may be implemented in the wearable case of FIG. 2A to control an emoji display or a display facing against a wearer of a wearable display device.

### DETAILED DESCRIPTION OF THE PREFERRED EMBODIMENTS

The detailed description of the invention is presented largely in terms of procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process, flowcharts or diagrams representing one or more embodiments of the invention do not inherently indicate any particular order nor imply any limitations in the invention.

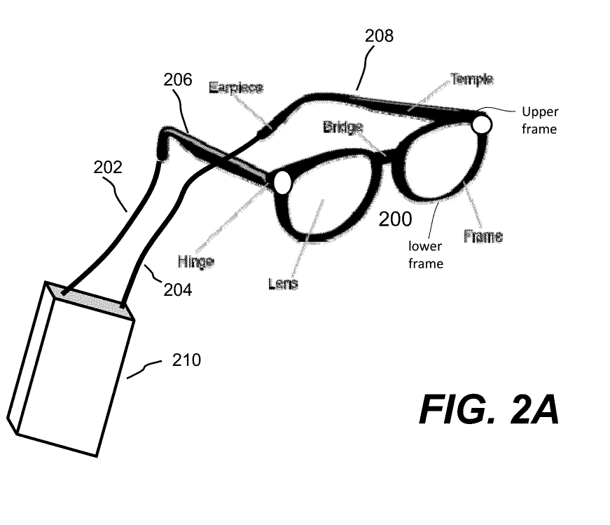

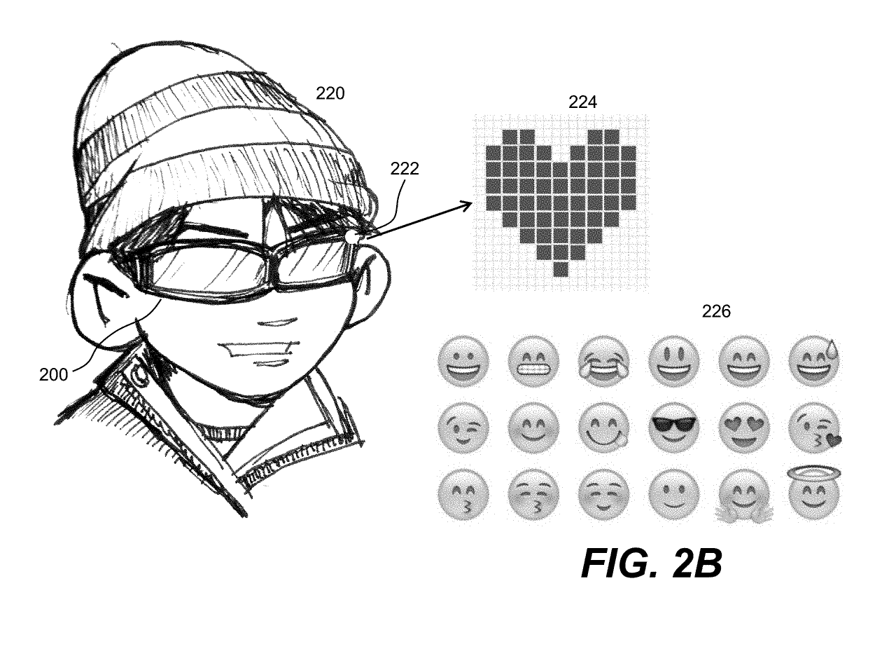

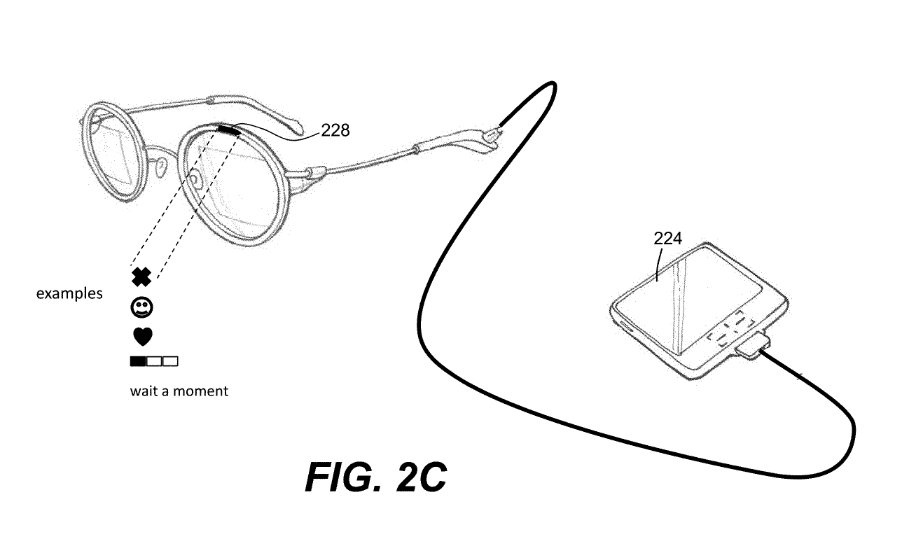

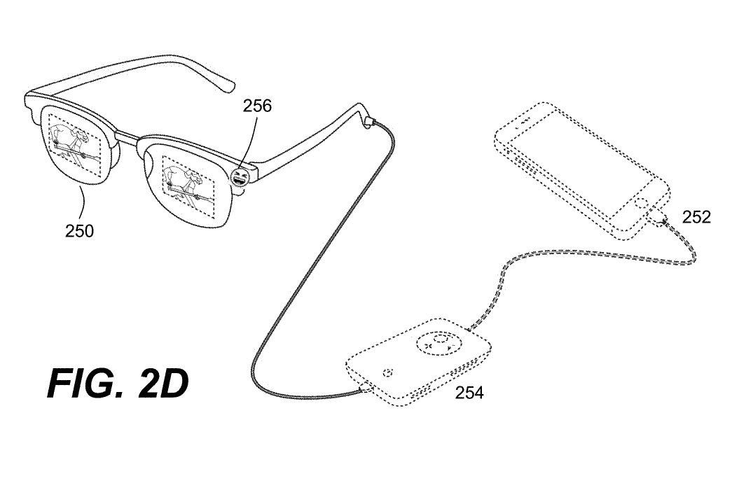

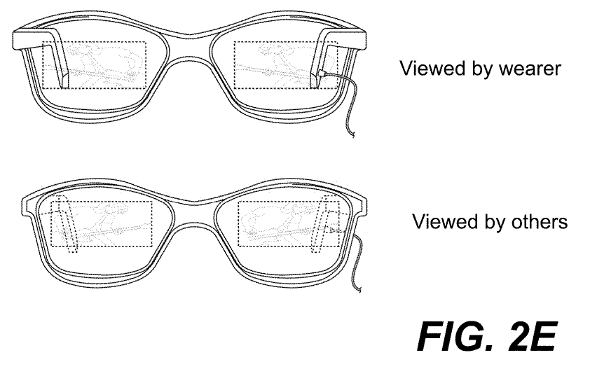

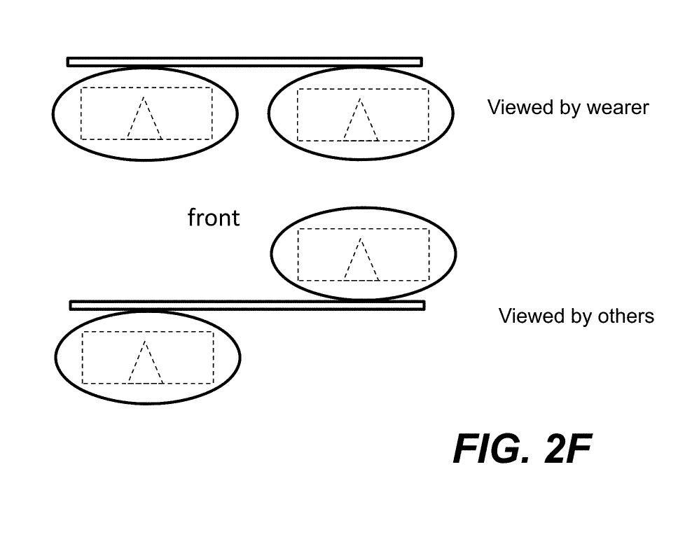

Embodiments of the present invention are discussed herein with reference to FIGS. 2A-4. However, those skilled in the art will readily appreciate that the detailed description given herein with respect to these figures is for explanatory purposes as the invention extends beyond these limited embodiments.

The present invention pertains to a system, a method, and an apparatus each of which is invented, uniquely designed, implemented or configured to enable a wearable display device, especially a head-mounted display, to show an expression. Depending on an application, the expression may be a text, an emoji, a score or a type of indication. As used herein, any pronoun references to gender (e.g., he, him, she, her, etc.) are meant to be gender-neutral. Unless otherwise explicitly stated, the use of the pronoun “he”, “his” or “him” hereinafter is only for administrative clarity and convenience. Additionally, any use of the singular or to the plural shall also be construed to refer to the plural or to the singular, respectively, as warranted by the context.

Referring now to the drawings, in which like numerals refer to like parts throughout the several views. FIG. 2A shows a pair of exemplary glasses 200 that may be used for show videos (e.g., VR/AR) according to one embodiment of the present invention. The glasses 200 appear no significant difference to a pair of normal glasses but include one or two flexible cables 202 and 204 that are respectively extended from the temples 206 and 208. According to one embodiment, each pair of the two flexible cables 202 and the temples 206 and 208 are integrated or removably connected at one end thereof and include one or more wires.

Both of flexible cables 202 and 204 are coupled at another end thereof to a portable computing device 210, where the computing device 210 generates or receives a video or images. The portable computing device 210 is typically designed to be enclosed in a case or enclosure to be carried in a pocket or attached to a body. The images are transported through either one or both of the cables 202 to the glasses 200, where the images are projected onto the lenses in the glasses 200 for the wearer to view. According to one embodiment, the cable is an optical fiber provided to optically transport a displayed image (e.g., from an LCS device) by total reflection within the fiber. The details of the operation using an optical fiber may be referenced in U.S. application Ser. No. 15/372,957. According to another embodiment, the cable includes a plurality of wires, one of the wires transmits an image (signal or data) from a memory device in the case 210 to the glasses for displaying the image therein. An example of such glasses is Smart glasses from www.vuzix.com that uses a set of wires to pick up images from an wearable case.

One of the important features in FIG. 2A is that one or more external displays 212 are implemented on the glasses 200. Depending on implementation, the external display 212 may be in LED, OLED, LCD or other display devices. The purpose is to display an expression to someone who may be looking at, talking to, or in the vicinity of the wearer of the glasses 200. As used herein, the external display 212 may also referred to herein as an emoji display.

FIG. 2B shows an example of a wearer or user 220 wearing the glasses 200 with an emoji display 222. As an example, an exploded version 224 of the emoji display 222 shows that a heart is being displayed. Depending on the implementation, the emoji display 222 may be positioned anywhere on or near the frame of the glasses 200. In one embodiment as shown in FIG. 2A, the emoji display 222 is positioned at the corner of the upper frame of the glasses 200. When needed, the wearer 220 may activate a command (e.g., voice, gesture or physical touch) to turn on the display 222 or the display 222 is automatically turned on to display an expression.

FIG. 2C shows one embodiment in which the case 220 is implemented to include a touch pad 224 that allows the wearer 220 to move a finger (not shown) to a certain position to activate the command or to select an emoji from a collection of emojis 226 as an example shown in FIG. 2B. As a result, the selected emoji is displayed on the emoji display 222 or a corresponding display 228 shaped accordingly is turned on as shown in FIG. 2C.

When the wearer 220 is viewing some content available from the Internet (e.g., shared by another person who may sit or stand before the wearer), the wearer may desire to express his feeling to the person, perhaps with reference to what he is viewing or whatever it matters. The wearer activates the display of an emoji so that the person may conceive the meaning. For example, when two are discussing something, one wearing the glasses 200 receives a note (e.g., email or text), the wearer has to attend to the note by pausing the discussion with the other person. It turns out that the wearer may take more time than anticipated in which case the wearer could cause the emoji display 222 to display a symbol or message to indicate “give me a second” or “just a moment”. In another example, the wearer may want to share a received media with the other person by showing a symbol or message to indicate “funny” or “interesting” to get the other person engaged. In still another example, the wearer may simply flirt with the other person by showing an emoji (e.g., with a heart) in which case the displayed emoji is not necessarily related to the content shown in the glasses 200. In yet another example, the emoji display 222 or 228 is used to indicate how long the wearer has been staring at a certain position in a screen/display or predefined object displayed in the glasses.

FIG. 2D shows another example in which the wearable display device 250 (display glasses) is controlled by a smartphone 252 via a controller 254, where the controller 354 is operated by a thumb or fingers. An expression or content displayed on the external display 256 is provided by the smartphone 252 and selected via the controller 254. The content may also be automatically supplied by the smartphone 252 in accordance with a scene being displayed in the glasses 250, where the scene is also supplied by the smartphone 252. The smartphone 252 executes an app implementing one embodiment of the present invention and communicates with the controller 254 in wired or wireless means. The app allows the user to set up if the emoji display needs manually or automatically controlled. In still another embodiment (not shown), the wearable display device 250 is coupled to or communicate with a smartphone, in which case the smartphone functions as an interface to allow the wearer to control the display of the external display 256.

FIG. 2E shows an exemplary wearable device 260 including two lenses, each showing an image or video being projected therein so that a wearer can see the image 262 when wearing the device 260. The lenses are see-through or transparent. In the event the wearer desires to share with another person standing in front of the wearer what he is watching, the wearer may allow the person to step close to the glasses, looking through the lenses. The image 262 may also be seen, but reversed. Without taking off the glasses, the wearer can trigger a command to flip the image 260 so that the person sees the image 262 normally while the wearer sees the image 262 reversed.

FIG. 2F shows an embodiment in which one of the lenses is flipped over. Similar to flip-up sunglasses in mechanism, a wearable device is designed to have a mechanism to allow one or both the lenses 270 and 272 to flip over according to one embodiment. FIG. 2F shows graphically one of the lenses 272 is flipped up to allow a standby to see what the wearer is watching. For example, the wearer is watching something being displayed in the lenses 270 and 272 and desires to share the content with someone standby or in front of him. The wearer can simply flip one of the lenses up to allow the standby to see the content while monitoring the progress of the playback on the other lens 270. To ensure the standby can see the content normally, the content is reversed or mirrored. In other words, when one or both of the lenses are flipped up to allow someone in front of the wearer to see the content, the content is mirrored. The process of reversing or mirroring an image is very well known and not to be further described herein.

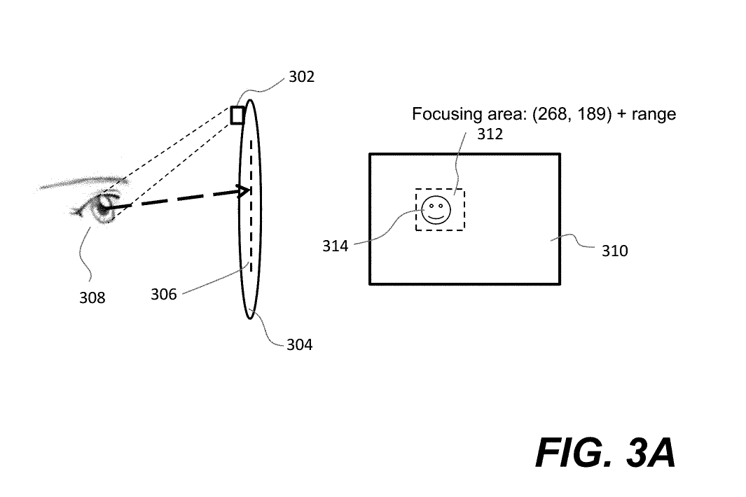

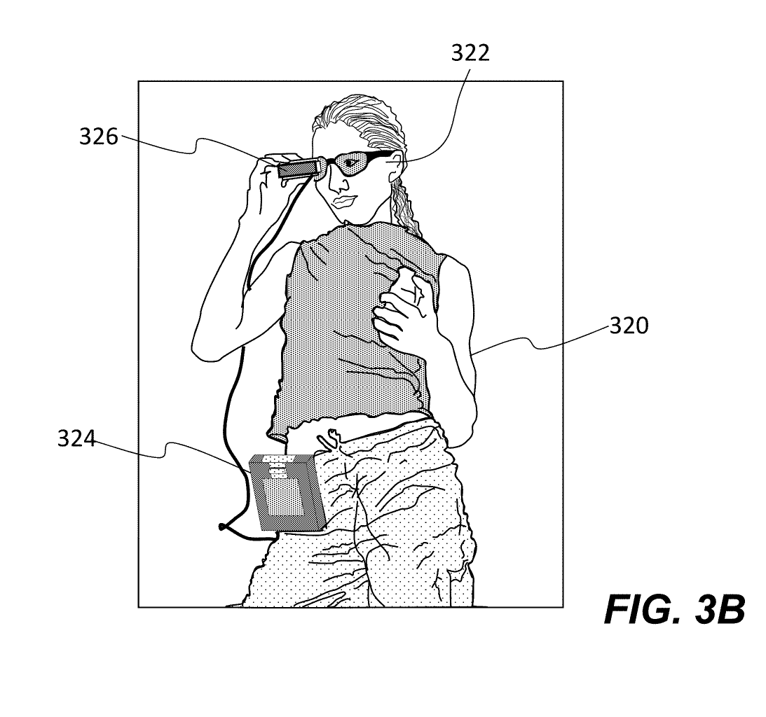

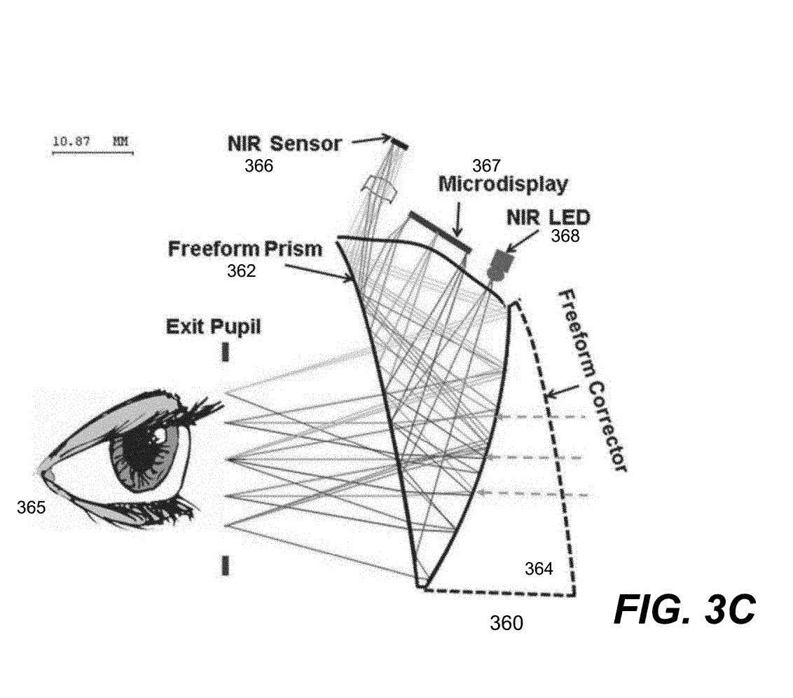

Referring now to FIG. 3A, it shows a diagram 300 in which a sensor 302 is mounted or embedded near a special lens 304 according to one embodiment of the present invention. As will be further described below, the special lens 304 is provided for an image 306 to be formed or displayed so that a human eye 308 can see the image 306 when wearing a wearable display device (e.g., the glasses 200). The sensor 302 (e.g., a CCD or CMOS) is provided to focus on and track the pupil. To avoid obscuring aspects of the present invention, the details of how to track the position of a pupil is not to be further provided herein. There are many available discussions about the tracking of a pupil. A search of key word “eye tracking” on Wikipedia gives a good description of techniques/devices for tracking an eye/pupil. A website www.pupil-labs.com provides an open source model about eye tracking. The focus and efforts are on pupil, a mobile eye tracking headset and open source software framework, and on developing open source tools for virtual reality, augmented reality, and mixed reality. In any case, the output of the pupil tracking can be expressed in an area or in coordinates (x, y). FIG. 3A shows an example of a focusing area 312 covering an object 314 being stared or focused by an eye.

According to one embodiment, when a wearer or user moves his eyes around in a scene displayed in a lens, resulting in the sensor 302 generating a sequence of images, the movement or trajectory of the pupil can be obtained from a pupil tracking technique based on the images. If it determines that the trajectory of the pupil is substantially similar to the movement of an object (e.g., a happy face 314 in the scene 310), it can be concluded that the user has been looking at the (moving) object 314 for a period of time. A display on the emoji display 222 or 228 may be used to indicate how the user has been looking at a specific object in a scene displayed in the glasses. Such a display may facilitate a type of visual communication with one or more people around the user. For example, in a video game competition, the emoji display 222 may be used for display a score for a judge to know how a contestant is doing with a video game.

FIG. 3B shows an example of a scene in which a performer 320 is wearing a pair of display glasses 322 that is coupled to a wearable case 324, very much resembling an example of using one embodiment of the present invention, except that the performer 320 is now looking at a camera 326 through one lens of the glasses 322. It is assumed that a wearer is looking at the case 324 and then moves to focus at the glasses 322 while the performer 320 is moving around. The pupil moves accordingly and follows the movement of the glasses 322. Through the pupil tracking, a process executing a module implementing a pupil tracking method determines the trajectory of the pupil. Comparing the trajectory with the content of the scene, it may be estimated that the wearer seems interested in the glasses 322. Accordingly, the emoji display 222 can be lit or show a predefined sign (e.g., a score or sign). Optionally, a corresponding service or content (e.g., advertisement) may be provided to or inserted in the display being watched by the user.

To facilitate the understanding of the lens 304 of FIG. 3A, FIG. 3C shows an exemplary lens 360 that may be used in the glasses of FIG. 3A or the glasses shown in FIGS. 2A-2C. The lens 360 includes two parts, a prism 362 and an optical correcting lens or corrector 364. The prism 362 and the corrector 364 are stacked to form the lens 360. As the name suggests, the optical corrector 364 is provided to correct the optical path from the prism 362 so that a light going through the prism 362 goes straight through the corrector 364. In other words, the refracted light from the prism 362 is corrected or de-refracted by the corrector 364. In optics, a prism is a transparent optical element with flat, polished surfaces that refract light. At least two of the flat surfaces must have an angle between them. The exact angles between the surfaces depend on the application. The traditional geometrical shape is that of a triangular prism with a triangular base and rectangular sides, and in colloquial use a prism usually refers to this type. Prisms can be made from any material that is transparent to the wavelengths for which they are designed. Typical materials include glass, plastic and fluorite. According to one embodiment, the type of the prism 362 is not in fact in the shape of geometric prisms, hence the prism 362 is referred herein as a freeform prism or lightguide, which leads the corrector 364 to a form complementary, reciprocal or conjugate to that of the prism 362 to form the lens 360.

On one edge of the lens 360 or the edge of the prism 362, there are at least three items utilizing the prism 362. Referenced by 367 is an imaging source that projects an image into the prism 362. Examples of the imaging source may include, but not be limited to, LCoS, LCD, and OLED. The projected image is refracted in the prism 362 and subsequently seen by the eye 365 in accordance with the shapes of the prism 362. In other words, a user wearing a pair of glasses employing the lens 462 can see the image being displayed through or in the prism 362.

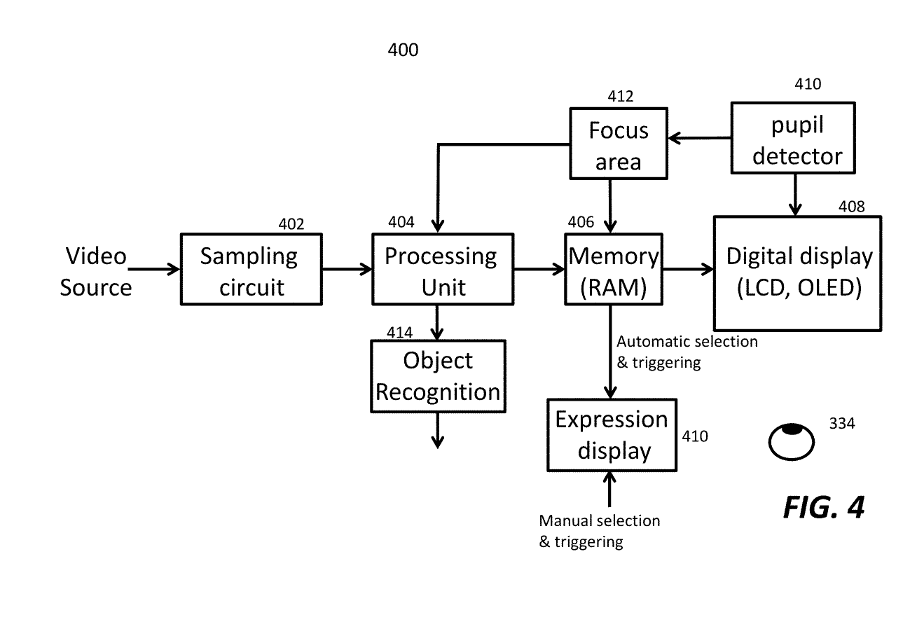

Referring now to FIG. 4, it shows a functional block diagram of a circuit 400 that may be implemented in the wearable case 210 of FIG. 2A to control an emoji display or a display facing against a wearer of a wearable display device. In other words, such a display is not meant for the wearer but provided for sharing some of the content being viewed by the wearer or an expression from the wearer while a scene is shown in the wearable display device.

A video source (e.g., a video, AR/VR content) is generated within the wearable device 210 and/or obtained by the wearable device 210 via the Internet. Optionally, a sampling circuit 402 is provided to resample the video source to ensure it is properly displayed in the display glasses when being presented. As the name suggested, the processing unit 404 is provided to process the video source. Depending on application, a video source may need to be processed to add additional objects or descriptions (e.g., AR) or “stitch” a sequence of views to generate a surrounding view (e.g., for VR). The processed image is buffered in a memory 406 for display on a display device 408, where the display device includes a mechanism of projecting into a special lens (e.g., the integrated lens 360 of FIG. 3C).

Apart from the prior art wearable display devices, the circuit 400 includes a driver (not shown) to drive an expression or emoji display 410. As described above, the emoji display 410 is typically positioned or imbedded somewhere on the external side of the glasses or glasses frame and faces outwards so that a person sitting or standing in front of the wearer may see it when it is turned on. The emoji display 410 may be automatically or manually turned on depending on implementation.

In one embodiment, a message (e.g., text, symbol or emoji) is manually selected by the wearer and displayed on the emoji display 410 whenever the wearer desires. In another embodiment, a message (e.g., text, symbol or emoji) is automatically selected and displayed on the emoji display 410 when a condition is met. One exemplary condition is that the wearer has stared at an identifiable object in a scene for a predefined period (e.g., 2, 3, 4 or 5 seconds). A pupil detector 411 is provided to track the movement of a pupil and outputs a trajectory thereof. The coordinates or trajectory of the pupil is provided to an area detector 412 that is programmed or designed to calculate a region of interest (ROI) or focusing area that the pupil has been staring at. With the information of the ROI, the processing unit 404 is programmed to determine what object has been falling in or corresponding to the ROI. When the focusing time exceeds a limit (e.g., 1.5 second), a trigger signal is sent from the memory 406 to drive the emoji display 410. Optionally, the object is determined at an objection recognition engine 414 that may be coupled to a database containing all available objects that may have been used in the scene. Based on a recognized object, a text, symbol or emoji may be automatically selected and presented to the emoji display 410 for display.

The present invention has been described in sufficient detail with a certain degree of particularity. It is understood to those skilled in the art that the present disclosure of embodiments has been made by way of examples only and that numerous changes in the arrangement and combination of parts may be resorted without departing from the spirit and scope of the invention as claimed. Accordingly, the scope of the present invention is defined by the appended claims rather than the forgoing description of embodiments.

We claim:

1. A wearable display device for reporting tracking of a predefined object in a video, the wearable display device comprising:
at least an integrated lens being held in a frame;
an external display facing outwards so that a person sits or stands in front of the wearer sees what is being displayed on the external display;
a pair of temples, at least one temple coupled to a cable, wherein the cable is extended beyond the temple to receive the video from a wearable case;
a projection mechanism, disposed near an end of the temple, receiving the video and projecting the video into the integrated lens, wherein the wearer sees the video in the integrated lens; and
at least a sensor, mounted near or on the frame, provided to focus onto a pupil starring at the predefined object moving in the video, wherein the external display displays an expression to show how the wearer has been following the predefined object moving in the video.

2. The wearable display device as recited in claim 1, wherein the expression is a score indicating how long the wearer has been following the predefined object moving in the video.

3. The wearable display device as recited in claim 2, wherein the sensor generates a set of images while focusing onto the pupil, the set of images is used to derive a trajectory of the predefined object moving in the video.

4. The wearable display device as recited in claim 3, wherein a time of the wearer having been following the predefined object moving in the video is estimated from the trajectory.

5. The wearable display device as recited in claim 4, wherein the score is related to the time.

6. A method for a wearable display device to report tracking of a predefined object in a video, the method comprising:
receiving the video via a cable in the wearable display device, wherein the wearable display device includes:
at least an integrated lens being held in a frame;
an external display facing outwards so that a person sits or stands in front of the wearer sees what is being displayed on the external display;
a pair of temples, at least one temple coupled to a cable, wherein the cable is extended beyond the temple to receive the video from a wearable case;
a projection mechanism, disposed near an end of the temple, receiving the video and projecting the video into the integrated lens, wherein the wearer sees the video in the integrated lens; and
generating a set of images from a sensor, mounted near or on the frame, provided to focus onto a pupil starring at the predefined object moving in the video;
displaying on the external display an expression to show how the wearer has been following the predefined object moving in the video.

7. The method as recited in claim 6, wherein the expression is a score indicating how long the wearer has been following the predefined object moving in the video.

8. The method as recited in claim 7, wherein the sensor generates a set of images while focusing onto the pupil, the set of images is used to derive a trajectory of the predefined object moving in the video.

9. The method as recited in claim 8, wherein a time of the wearer having been following the predefined object moving in the video is estimated from the trajectory.

10. The method as recited in claim 9, wherein the score is related to the time.
